(19) United States
(12) Patent Application Publication
(10) Pub. No.: US 2009/0116257 A1
(43) Pub. Date: May 7, 2009

(54) Low profile lightbar with IR illumination

(76) Inventors: William E. Rosemeyer, Wexford, PA (US); James M. Helms, Mars, PA (US)

Correspondence Address: KAREN TANG-WAI SODINI, 216 horseshoe drive, MARS, PA, 16046, US

(21) Appl. No.: 12/284,747

(22) Filed: Sep. 24, 2008

Related U.S. Application Data
(60) Provisional application No. 61/000,704, filed on Oct. 25, 2007.

(51) Int. Cl. B60Q 1/26; G01J 3/10

(52) U.S. Cl. 362/493; 250/504 R

(57) ABSTRACT

A low-profile aerodynamic automotive lightbar including integrated arrangements of visible and infrared light sources, providing visible light and infrared illumination. The visible light sources can be visible light LEDs, or HID lights, or halogen lights, for use in conducting routine policing activities. The infrared light sources are infrared LEDs, for use in covert operations or surveillance. The invention is of use, for example, as an accessory for utility vehicles, including police or security vehicles (such as the Ford Crown Victoria police cruiser) and tactical military vehicles (such as the HMMWV).

### CROSS REFERENCE TO RELATED APPLICATIONS

This application claims the benefit of provisional patent application Ser. No. 61/000,704 filed by the present inventor on Oct. 25, 2007.

### FIELD OF THE INVENTION

The present invention pertains to the field of electric lightbars using infrared (IR) light-emitting diodes (LEDs) for mounting on motorized vehicles, including tactical military vehicles.

### BACKGROUND OF THE INVENTION

A lightbar, as that term is used here, is an elongated structure, typically substantially spanning the width of a vehicle, but may be of a lesser extent. A lightbar holds lights for mounting or attaching to a vehicle, typically on top of the vehicle cab but can also be mounted on running boards and other locations on the vehicle body, and includes wiring harnesses for providing electrical power to the lights, and for turning the lights on and off, or for altering operation of a light, e.g. to change from continuous illumination to flashing. Lightbars typically also have floodlights, used to illuminate a large area, or in the case of civilian police and security vehicles, take-down spotlights that are turned on to illuminate the entire back windshield of a suspect's vehicle as well as to make it difficult for the suspects themselves to look back and see details of the police or security vehicle or of its occupants.

Lightbars providing different colored light, typically mounted on top of military and civilian police and security vehicles, are useful for many commonly known reasons. Military “blackout” operations and police or security covert surveillance operations often require operating a vehicle at night, at moderately high speed, without being detected. It would be advantageous to add infrared (IR) illuminators to such lightbars, for use in blackout operations or covert surveillance. In addition, since police and security vehicles are often operated at high speed, it would be advantageous to provide a lightbar that is as aerodynamic as possible, or at least that interferes very little with air flow over and around the vehicle, which was designed to be aerodynamic without a lightbar mounted on top.

Thus, what is needed is a lightbar for mounting to a vehicle that provides visible and colored light, take-down spotlights, IR illumination, and is aerodynamic.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a perspective drawing of a low profile lightbar according to the invention.

FIG. 2 is an exploded view of the lightbar of FIG. 1.

FIG. 3 is a top view of one embodiment of the lightbar according to the invention, showing an arrangement of visible light illuminators and IR light illuminators (IR LEDs).

### DRAWINGS LIST OF REFERENCE NUMERALS

The following is a list of reference labels used in the drawings to label components of different embodiments of the invention, and the names of the indicated components.
10 low profile frame
10a frame interior
11 lightbar
21 top and bottom base plate
22 support members
23 wall element
24a infrared (IR) light illuminator
24b visible light illuminator
26 takedown spotlight
32 fastener

### DETAILED DESCRIPTION

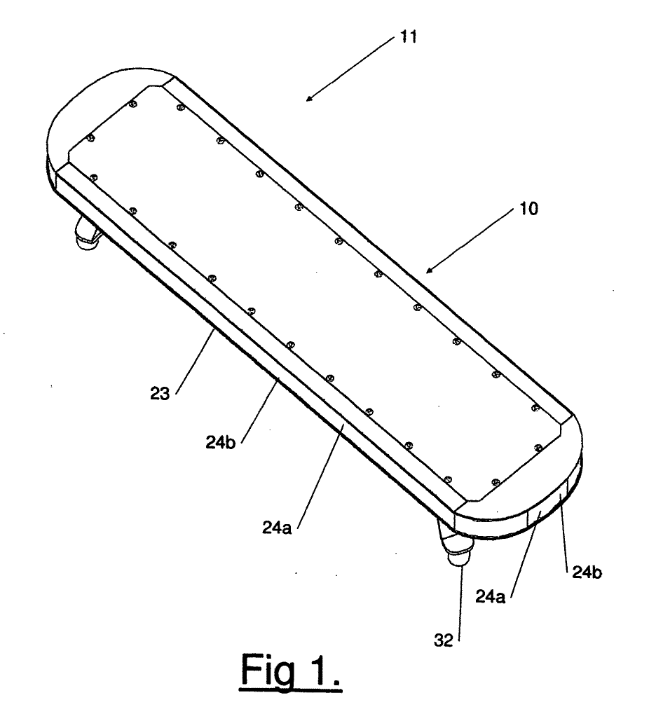

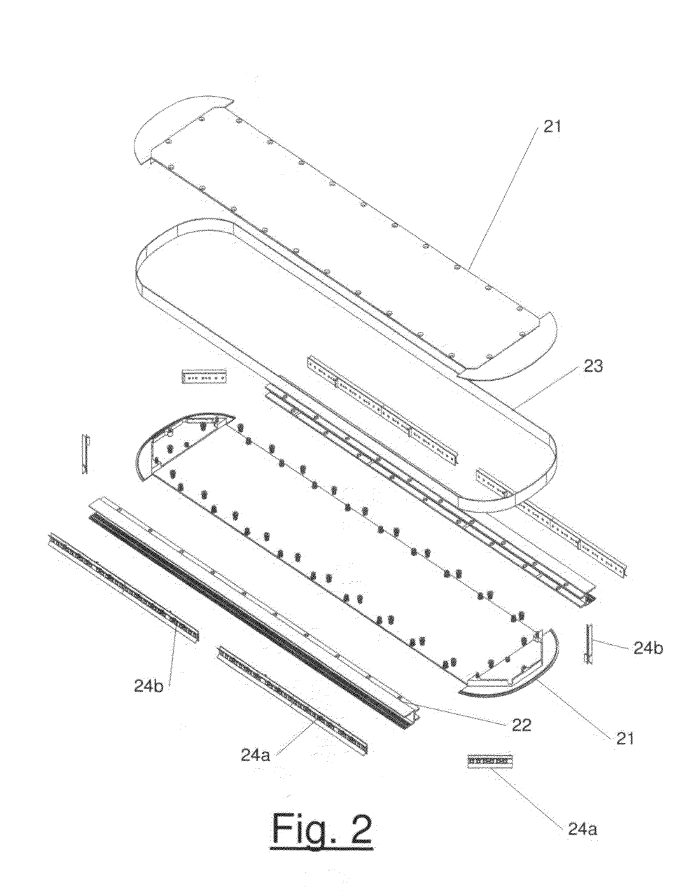

As can be seen from FIGS. 1-3, the invention provides a low profile lightbar 11 including IR light illuminators 24a and visible light illuminators 24b, and including fasteners 32 for fastening the lightbar onto the roof of a vehicle, onto a bumper, or onto side-mounted running boards. The lightbar is typically configured to receive electric power from the vehicle battery, using a wiring harness for the same, and a control panel (not shown) for mounting in the cabin of the vehicle, including switches (not shown) for switching on and off the IR light illuminators and the visible light illuminators, and advantageously, for preventing turning on the visible light illuminators if the IR light illuminators are turned on.

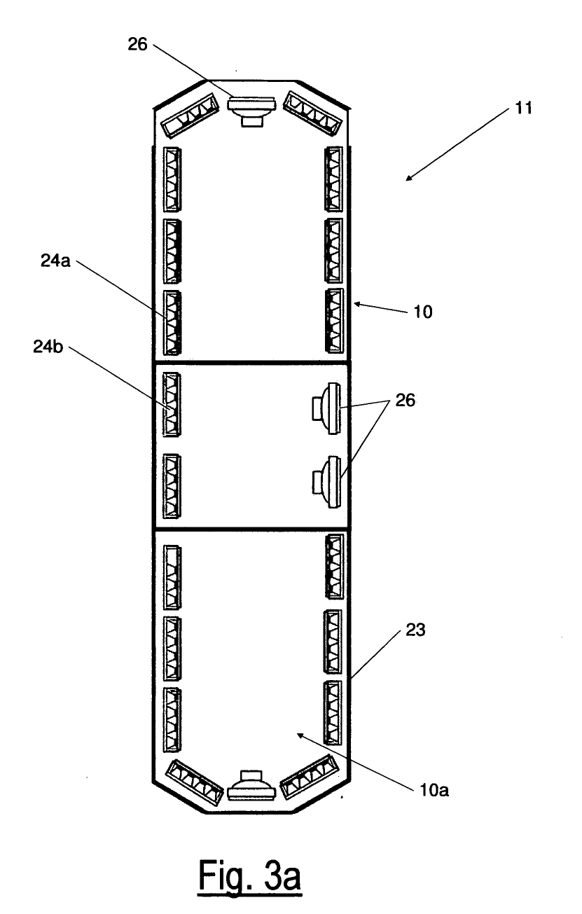

The lightbar 11 comprises a low profile frame 10 made of at least one outermost wall element 23 sandwiched between two or more base plates 21, creating a frame interior 10a. Inside the frame interior 10a and located around the periphery of the frame 10 along the inside face of the wall element 23 are one or more IR light illuminators 24a and one or more visible light illuminators 24b possibly including a take-down spotlight 26 (FIG. 3). Each of the one or more IR light illuminators is typically a plurality of IR LEDs wired to operate as a single IR light source, but may be a single IR LED.

In some embodiments, the illuminators 24a 24b are retained in the lightbar 11 by support members 22, but in other embodiments the illuminators 24a 24b are affixed to the base plates 21. The wall element 23 may be load-bearing, or non-structural flashing (layered protection) affixed to internal support members. The outermost wall element is made of translucent or transparent material and designed to protect the internal components of the lightbar from damage due the elements. The base plates 21 may have protruding flanges extending beyond the wall elements. The frame may be monolithic or it may comprise several sub-frames fastened together, e.g., a center frame and two bolt-spliced end frames. Butt plates may be used to separate the sub-frames. Elements of the frame may be fabricated from any suitable material, including steel, aluminum, plastic, or composites. An advantageous embodiment of the invention uses transparent plastic.

In the embodiment of the invention shown more particularly in FIG. 3, where the visible light illuminators 24b include the take-down spotlight 26, the take-down spotlight can use either a high intensity discharge (HID) light, a halogen light, or one or more visible light LEDs as a light source. The non take-down visible light illuminators included in the lightbar in the embodiment shown in FIG. 3 are visible light LEDs disposed about the periphery of the lightbar frame 10, so as to fully or partially illuminate the regions in front of, behind, and/or to either side of the vehicle (depending on where the LED is mounted on the lightbar). A typical white light LED suitable for the invention is an OSRAM LE W E3B, available from OSRAM Opto Semiconductors, Inc., of Santa Clara, Calif.

Any or all of the illuminators 24a 24b are advantageously recessed into a lightbar frame. Any or all of the wall elements may further be shielded by a protective transparent or translucent barrier (not shown) so as to protect the (visible and IR) illuminators 24a 24b from the elements, airborne debris, or other sources of wear.

Visible light illuminators are typically a combination of three colors, usually any three of white, blue, yellow and red, although other colors may be used. (In embodiments using LEDs to provide visible light, the white light is typically provided by LEDs using phosphor conversion to produce white light from some single-frequency light.)

In one embodiment of the invention, the lightbar uses only LEDs, for both visible light and IR light, and comprises 120 LEDs, some red, some white, some blue, and some IR LEDs. Of these, about 50 are mounted to illuminate in the forward direction, about 50 are mounted for illumination rearward of the vehicle, and about 10 are mounted on each side of the lightbar, for providing illumination to the sides of the vehicle. This provides illumination in 360 degrees around the vehicle, i.e. in all directions (in the horizontal plane).

The lightbar is configured to have multiple user-selectable flashing patterns (typically up to sixteen), selectable from the control panel (not shown). In some embodiments only the visible light illuminators 24b are provided so as to turn on and off according to a selected flashing pattern, however in some embodiments the IR light illuminators 24a may also be provided so as to flash according to a flashing pattern, as a way of signaling other police or utility vehicles.

A lightbar according to the invention advantageously includes a low-power mode, enabled using the control panel (not shown), whereby the illuminators 24a 24b may be dimmed to some fractional portion of their full-power output.

A lightbar according to the invention is typically powered by the host vehicle's internal electrical system via the wiring harness, and typical embodiments may support 12-volt and/or 24-volt DC power.

A lightbar according to the invention has a low profile form factor for the sake of reducing aerodynamic drag. More specifically, a lightbar according to the invention is typically less than one inch high, but may be up to two inches high, and the elongated dimension is typically from 36 to 54 inches. For lightbars exceeding one-inch in height, the edges of the base plates 21 and the wall element 23 can be beveled to reduce air drag. A lightbar according to the invention thus has improved aerodynamics, lessening the impact of the lightbar on overall vehicle stability, and improving fuel economy.

The invention is of use, e.g., as an accessory for utility vehicles, including police and tactical military vehicles, such as the Ford Crown Victoria police cruiser, motorcycles, or the HMMWV (high mobility multipurpose wheeled vehicle). As is clear from the description, though, the invention is clearly of use in other than such vehicles, and in general is of use in case of military or law enforcement vehicles or military or civilian security vehicles intended to be driven in low-light conditions, possibly in conjunction with night vision devices.

It is to be understood that the arrangements shown and described above and in the attachments are only illustrative of the application of the principles of the present invention. Numerous modifications and alternative arrangements may be devised by those skilled in the art without departing from the scope of the present invention, and the appended claims are intended to cover such modifications and arrangements.

1. A lightbar apparatus for a vehicle, comprising:
a low profile frame (10), the frame comprising at least one horizontal base plate (21) connected to a wall element (23) and having an interior space (10a);
one or more IR light illuminators (24a) and one or more visible light illuminators (24b), all affixed to the base plate (21) in a desired arrangement;
a control panel for enabling either the IR light illuminators (24a) or the visible light illuminators (24b), configured to prevent turning on the visible light illuminators (24b) if the IR light illuminators (24a) are turned on; and
fasteners (32) for fastening the low profile frame (10) onto a vehicle.

2. The apparatus of claim 1, further comprising means for enabling a low power mode, whereby a light output from the illuminators (24a 24b) may be dimmed to a level less than their maximum light output.

3. The apparatus of claim 2, wherein the low power mode dims the illuminators (24a 24b) to 25% of their brightest level.

4. The apparatus of claim 1, further comprising means for selecting various flash-patterns for the IR light illuminators (24a) and/or the visible light illuminators (24b).

5. The apparatus of claim 1, wherein the one or more visible light illuminators (24b) include one or more halogen lights, one or more high intensity discharge lights, or one or more visible light LEDs.

6. The apparatus of claim 5, wherein at least one of the one or more visible light illuminators (24b) is configured to direct light in a direction so as to serve as a take-down spotlight (26).

7. The apparatus of claim 1, wherein the frame is less than 1 inch high.

8. The apparatus of claim 1, wherein the one or more visible light illuminators (24b) and the one or more IR light illuminators (24a) are disposed about the periphery of the frame (10) so as to provide visible and infrared illumination in 360 degrees around the vehicle.

9. The apparatus of claim 8, wherein the one or more visible light illuminators (24b) include a combination of red, blue, yellow, and white light LEDs.

10. The apparatus of claim 1, wherein the frame is less than 2 inches high and is beveled so as to reduce air resistance.
